(19) United States
(12) Patent Application Publication
(10) Pub. No.: US 2026/0193397 A1
(43) Pub. Date: Jul. 9, 2026

(54) AQUEOUS DISPERSION OF MULTIPHASE POLYMER PARTICLES

(71) Applicant: Rohm and Haas Company, Collegeville, PA (US)

(72) Inventors: Andrew Hejl, Lansdale, PA (US); Ethan C. Glor, Ambler, PA (US); lbrahim Eryazici, Phoenixville, PA (US); Brian R. Einsla, Collegeville, PA (US)

(21) Appl. No.: 19/133,291

(22) PCT Filed: Dec. 12, 2023
(86) PCT No.: PCT/US2023/083567

§ 371 Date: May 28, 2025

Related U.S. Application Data
(60) Provisional application No. 63/433,218, filed on Dec. 16, 2022.

(51) Int. Cl. C08F 265/06; C09D 7/40; C09D 7/41

(52) U.S. Cl. CPC C08F 265/06; C09D 7/41; C09D 7/68; C09D 7/69

(57) ABSTRACT

The present invention relates to a composition comprising an aqueous dispersion of porous core-shell polymer particles having a water-occluded core containing a core polymer phase comprising structural units of a salt of a carboxylic acid monomer; structural units of n-butyl acrylate or 2-ethyhexyl acrylate, or a combination thereof; and structural units of methyl methacrylate; and a shell comprising one or more acrylate monomers; and styrene. The porous core-shell polymers are useful as a component of a basecoat intermediate layer for a thermosensitive paper article.

### BACKGROUND OF THE INVENTION

The present invention relates to a composition comprising an aqueous dispersion of multiphase polymer particles that are useful as porous hollow sphere pigments for coating applications.

Thermosensitive paper is a multilayered recording material that includes a paper substrate, an intermediate insulating layer comprising a binder and hollow sphere pigments (HSPs), and an image forming layer (see U.S. Pat. No. 10,730,334 B1). Printing performance in direct thermal printing applications depends largely on maximizing void fraction of the HSPs. The larger the void fraction, the less print energy required to create an image. Void fraction alone is not predictive of print performance, however: higher void fractions result in thinner particle shells with an increased likelihood of particle collapse and a concomitant degradation in print performance. It would therefore be an advantage in the field of thermal printing to improve print performance by providing HSPs with increased void fractions and collapse resistance.

### SUMMARY OF THE INVENTION

The present invention addresses a need in the art by providing, in one aspect, a composition comprising an aqueous dispersion of porous core-shell polymer particles having:
a) a water-occluded core containing a core polymer phase comprising 1) from 30 to 55 weight percent structural units of a salt of a carboxylic acid monomer; 2) from 4.5 to 55 weight percent structural units of n-butyl acrylate or 2-ethyhexyl acrylate, or a combination thereof; and 3) from 4.5 to 55 weight percent structural units of methyl methacrylate;
b) a shell comprising 1) from 3.4 to 16 weight percent structural units of one or more acrylate monomers selected from the group consisting of ethyl acrylate, n-butyl acrylate, and 2-ethylhexyl acrylate; and 2) from 80 to 96.4 weight percent structural units of styrene;
wherein the porous core-shell polymer particles have a number average particle size in the range of from 750 nm to 2 μm.

The composition of the present invention is a precursor to porous HSPs with high void fraction and collapse resistance.

### BRIEF DESCRIPTION OF DRAWINGS

FIG. 1 is a scanning electron micrograph of intact porous hollow sphere pigments.

FIG. 2 is a scanning electron micrograph of collapsed non-porous hollow sphere pigments.

### DETAILED DESCRIPTION OF THE INVENTION

In one aspect, the present invention is a composition comprising an aqueous dispersion of porous core-shell polymer particles having:
a) a water-occluded core containing a core polymer phase comprising 1) from 30 to 55 weight percent structural units of a salt of a carboxylic acid monomer; 2) from 4.5 to 55 weight percent structural units of n-butyl acrylate or 2-ethyhexyl acrylate, or a combination thereof; and 3) from 4.5 to 55 weight percent structural units of methyl methacrylate; and
b) a shell comprising 1) from 3.4 to 16 weight percent structural units of one or more acrylate monomers selected from the group consisting of ethyl acrylate, n-butyl acrylate, and 2-ethylhexyl acrylate; 2) and from 80 to 96.4 weight percent structural units of styrene;
wherein the porous core-shell polymer particles have a number average particle size in the range of from 750 nm to 3 μm.

The weight ranges of the recited structural units of the monomers in the core polymer phase are all based on the weight of the core polymer phase; similarly, the weight ranges of the recited structural units of the monomers in the shell are all based on the weight of the shell.

The aqueous dispersion of porous water-occluded polymer particles is advantageously prepared in multiple stages as follows: Core polymer particles not occluded with water are prepared by copolymerizing a monomer emulsion (ME 1) comprising a carboxylic acid monomer, an acrylate monomer, and methyl methacrylate under emulsion polymerization conditions. The core polymer particles may be prepared by polymerizing ME 1 in contact with a seed polymer particle, typically a copolymer of methyl methacrylate and methacrylic acid. The ratio of seed polymer particle to ME1 is usually in the w/w range 1:99 to 50:50. The core polymer particles may be isolated or used directly in the production of the core-shell polymer particles.

Monomers used to form the shell may be polymerized in a single stage or in two stages. The single-stage polymerization can be carried out as follows: on completion of addition of ME 1 to the reactor, a second monomer emulsion (ME 2) comprising from 3.4 to 16 weight percent acrylate monomer and from 80 to 96.4 weight percent styrene, based on the weight of monomers in the second monomer emulsion, is added the core polymer dispersion in the reactor under emulsion polymerization conditions. The weight-to-weight ratio of shell to core polymer phase is preferably in the range of from 3:1 to 7:1. When the addition of ME 2 is completed, hot deionized water and a neutralizing amount of a base such as NH₄OH or an alkali metal hydroxide such as NaOH is added to the mixture. This neutralization step causes swelling of the particle with concomitant occlusion of water in the core.

The two-stage polymerization can be accomplished as follows: Upon completion of the reaction of ME 1 and ME 2, and after a suitable hold period (~15 min), a third monomer emulsion (ME 3) containing styrene is fed into the reactor in the presence of a radical inhibitor such as 4-hydroxy TEMPO. Upon completion of the addition of ME 3, hot deionized water and a neutralizing amount of a base is added to the mixture. The dispersion is advantageously chased with t-butyl hydroperoxide (t-BHP) and isoascorbic acid (IAA) and the contents are filtered to remove any coagulum. The weight-to-weight ratio of ME 3 to ME 2 is typically in the range of from 0.08:1 or from 0.1:1, to 0.5:1 or to 0.3:1 or to 0.2:1. The water-occluded core contains a core polymer phase comprising from 30, preferably from 35, and more preferably from 38 weight percent, to 55, preferably to 45, more preferably to 42 weight percent structural units of a salt of a carboxylic acid monomer, preferably a salt of acrylic acid or methacrylic acid, more preferably a salt of methacrylic acid, most preferably sodium methacrylate or ammonium methacrylate. As used herein, the term “structural units” refers to the remnant of the recited monomer after polymerization. For example, a structural unit of a salt of methacrylic acid, where M⁺ is a counterion, preferably a lithium, sodium, potassium, or ammonium counterion, is as illustrated:

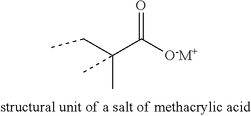

The total contribution of structural units of butyl acrylate and 2-ethylhexyl acrylate in the core polymer phase is in the range of 4.5 to 55 weight percent. Preferably, the core polymer phase comprises from 9 or from 12 weight percent, to 55 or to 50 or to 45 weight percent structural units of the acrylate, preferably n-butyl acrylate. The core polymer phase further comprises from 9 or from 13 or from 18 weight percent, to 55 or to 50 or to 45 weight percent structural units of methyl methacrylate. Preferably, at least 90, more preferably at least 95, and most preferably at least 99 weight percent of the core polymer phase comprises structural units of a salt of methacrylic acid, the acrylate monomer, and methyl methacrylate.

The shell comprises from 3.4, preferably from 4, and more preferably from 5 weight percent, to 16, preferably to 15, more preferably to 13 weight percent structural units of an acrylate monomer, preferably n-butyl acrylate, and from 80, preferably from 84, more preferably from 85, and most preferably from 87 weight percent, to 96.4, preferably to 94, and most preferably to 93 weight percent structural units of styrene.

The shell may further comprise structural units of acid monomer salts such as ethylenically unsaturated carboxylic acid salts including lithium, sodium, potassium, and ammonium salts of acrylic acid and methacrylic acid; ethylenically unsaturated sulfonates such as sodium 4-vinylbenzenesulfonate (sodium styrene sulfonate); and phosphorus acid salts such as phosphoethyl methacrylate (PEM). The concentration of structural units of acid monomer salts in the shell is preferably in the range of from 0.1 or from 0.5 or from 1.0 or from 1.5 weight percent, to 5 or to 3.5 or to 3.0 weight percent. The shell preferably comprises structural units of a salt of methacrylic acid, more preferably sodium methacrylate or ammonium methacrylate.

The shell may also further comprise structural units of a multiethylenically unsaturated monomer such as allyl methacrylate (ALMA) or divinyl benzene. The concentration of structural units of the multiethylenically unsaturated monomer in the shell is preferably in the range of from 0.05, more preferably from 0.1 weight percent, to preferably 1, more preferably to 0.5 weight percent.

The weight-to-weight ratio of the shell to the core polymer phases is preferably in the range of from 2.5:1 or 3.0:1 or from 3.5:1 or from 3.8:1, to 7:1, or to 6.5:1 or to 6.0:1 or to 5.0:1 or to 4.5:1 or to 4.2:1.

The resultant porous core-shell polymer particles have a number average particle size diameter in the range of 750 nm or from 900 nm or from 1.1 μm, to 2 μm or to 1.8 μm or to 1.5 μm, as measured by scanning electron microscopy. The solids content of the aqueous dispersion of core-shell porous polymer particles is preferably in the range of from 10 to 20 weight percent.

It has surprisingly been discovered that the inclusion of structural units of acrylate monomers in the core polymer phase and the shell are essential for preparing porous HSPs with a high void fraction and resistance to collapse. The inclusion of structural units of acrylate monomer reduces T_{g} of the polymer phases, thereby providing a way to prepare water-occluded HSP precursors. The reduction of T_{g} alone, however, cannot explain the improved efficiency of the HSPs because shells that are plasticized by virtue of the presence of unreacted styrene (ME 3) do not yield HSPs with comparable void fractions and collapse resistance.

The composition of the present invention is useful as a component of a basecoat intermediate layer for a thermosensitive recording material. A basecoat formulation is prepared by blending the aqueous dispersion of porous water-occluded core-shell polymer particles with one or more binders such as a styrene-butadiene latex, a styrene-acrylic latex, or polyvinyl alcohol. The basecoat formulation optionally comprises additional pigments such as calcined clay. The basecoat formulation is then coated onto a surface of a sheet of paper, then dried and conditioned by means well known in the art. A thermosensitive layer is then coated onto the basecoat with further drying. Accordingly, another aspect of the present invention is a thermosensitive recording material comprising a paper substrate, a 1-μm to 20-μm or to 10-μm thick basecoat layer comprising the composition of the present invention and a binder, and a 1-μm to 30-μm thick thermosensitive recording layer, wherein the basecoat layer is disposed between the thermosensitive recording layer and the paper substrate.

The dried basecoat comprises porous HSPs with a void fraction in the range of from 50, preferably from 55, more preferably from 60, more preferably from 65, and most preferably from 70 percent, to 80 or to 75 percent. As used herein, “porous” refers to one or more channels that extend from the surface of the HSP to the voided portion. The HSP comprises, based on the total weights of the core polymer phase and the shell, from 60 or from 64 or from 66 weight percent, to 80 or to 78 or to 76 weight percent structural units of styrene, from 1 or from 3.5 or from 7 or from 9 weight percent, to 20 or to 18 weight percent structural units of the acrylate monomer, preferably n-butyl acrylate, from 0.5 or from 2 or from 4 weight percent to 15 or to 10 weight percent structural units of methyl methacrylate, and from 5 or from 6 weight percent, to 20 or to 15 or to 10 weight percent structural units of methacrylic acid or a salt thereof, preferably structural units of methacrylic acid or sodium methacrylate.

### EXAMPLES

### Preparation of Seed Polymer Dispersion

Deionized water (1948.40 g) and sodium dodecylbenzene sulfonate (NaDDBS, 1.78 g, 22.5% in water) were charged to a 5-L, 4-necked round bottom flask and heated to 85° C. under N₂. In a separate vessel, a monomer emulsion containing DI water (715.00 g), NaDDBS (20.00 g, 22.5% in water), methyl methacrylate (MMA, 780.00 g), and methacrylic acid (MAA, 10.00 g) was prepared. A portion of the monomer emulsion (10.8%, 165.00 g) was charged to the reactor and rinsed with DI water (35 g). After removing this portion of the monomer emulsion, additional DI water (50 g), NaDDBS (14.80 g) and MAA (510.00 g) were added to the monomer emulsion. A solution of sodium persulfate (5.50 g) in DI water (30 g) was charged to the reactor. An exotherm was observed and allowed to hold at the peak temperature for 15 min. The remainder of the ME was fed to the reactor over 120 min with the temperature set to 85° C. At the completion of feeds, the addition vessels were rinsed with DI water (50 g) and the reaction was held for 20 min at 85° C. The contents of the reactor were then cooled to room temperature and filtered to remove any coagulum. The resulting dispersion had a solids content of 31.2% and a particle size of 187 nm.

### Intermediate Example 1—Preparation of a Dispersion of Core Polymer Particles

Deionized water (1301.00 g), and glacial acetic acid (0.51 g) were charged to a 5-L, 4-necked round bottom flask and heated to 91° C. under N₂. In a separate vessel, a monomer emulsion containing DI water (827.34 g), Disponil FES-993 surfactant (31% active, 13.87 g), MMA (770.00 g), butyl acrylate (BA, 140.00 g) and MAA (490.00 g) was prepared. An initiator solution of sodium persulfate (3.50 g) in DI water (150 g) was also prepared. A solution of sodium persulfate (3.50 g) in DI water (45 g) was charged to the reactor and rinsed with DI water (10 g). A portion of the seed polymer dispersion (157.05 g, 31.2% solids, 187 nm) was charged to the reactor and rinsed with DI water (30 g). The monomer emulsion and initiator solution were then fed to the reactor over 120 min with the monomer emulsion fed at 50% rate for the first 20 min, while maintaining the reaction at 83° C. Upon completion of the feeds the vessels were rinsed with DI water (60 g) and the reaction held at 83° C. for 30 min. The contents of the reactor were then cooled to room temperature and filtered to remove any coagulum. The resulting core polymer dispersion had a solids content of 36.4% and a particle size of 552 nm.

The core polymer dispersions of Intermediate Examples 2-5, and Comparative Intermediate Examples 1 and 2 were prepared according to the procedure for Intermediate Example 1. The weights of BA and MMA used to prepare the core from the seed polymer dispersion, as well as the solids content, and particle sizes are illustrated in Table 1. Particle sizes were z-average particle sizes measured by dynamic light scattering.

TABLE 1
Core Composition of Intermediate and
Comparative Intermediate Examples

| Ex. No | BA (g) | MMA (g) | MAA (g) | Solids (%) | PS (nm) |
|---|---|---|---|---|---|
| Comp. Int. 1 | 0 | 910 | 490 | 36.4 | 552 |
| Int Ex. 1 | 140 | 770 | 490 | 36.6 | 547 |
| Int Ex. 2 | 280 | 630 | 490 | 36.6 | 541 |
| Int Ex. 3 | 420 | 490 | 490 | 36.3 | 520 |
| Int Ex. 4 | 560 | 350 | 490 | 36.5 | 551 |
| Comp Int. 2 | 910 | 0 | 490 | 36.6 | 496 |

### Example 1—Preparation of Water-Occluded Core-Shell Polymer Particles, 6% BA in Shell

Deionized water (2650.00 g), and glacial acetic acid (0.20 g) were charged to a 5-L, 4-necked round bottom flask and heated to 96° C. under N₂. In a separate vessel, a monomer emulsion containing DI water (148.89 g), NaDDBS (1.71 g, 22.5% in water), styrene (STY, 367.20 g), BA (24.00 g), allyl methacrylate (ALMA, 0.80 g), and MAA (8.00 g) was prepared. An initiator solution of sodium persulfate (1.51 g) in DI water (76.80 g) was also prepared. A solution of sodium persulfate (0.76 g) in DI water (10.40 g) was charged to the reactor and rinsed with DI water (4 g). A portion of the Intermediate Example 1 core polymer dispersion (273.45 g, 36.6% solids, 541 nm) was charged to the reactor and rinsed with DI water (32 g). The monomer emulsion and initiator solution were then fed to the reactor over 120 min, while maintaining the reaction at 90° C. Upon completion of the feeds the vessels were rinsed with DI water (28 g total) and the reaction held at 90° C. for 15 min. A solution of iron sulfate heptahydrate (0.15% solution, 12.12 g) and VERSENE™ Chelating Agent (A Trademark of The Dow Chemical Company or Its Affiliates, 1.0% solution, 1.90 g) was added to the reactor. A solution of t-butylhydroperoxide (t-BHP, 70% solution, 2.40 g in 20 g DI water) was added to the reactor, followed by the gradual addition of isoascorbic acid (IAA 0.66 g in 38.40 g DI water) over 15 min. A neutralizer solution prepared from DI water (120 g), NaDDBS (10.68 g, 22.5% in water), and ammonium hydroxide (30%, 35.56 g) was added gradually to the reactor over 15 min. The vessel containing the neutralizer solution was rinsed with DI water (16 g), which was added to the reactor. The reaction temperature was maintained at 90° C. for 60 min, after which time the contents of the reactor were cooled to room temperature and filtered to remove coagulum. The resulting dispersion had a solids content of 13.0%, a void fraction of 70.4%, and a particle size of 1.35 μm.

Examples 2-4 and Comparative Examples 1 and 2 were prepared substantially as described for Example 1 except that the corresponding Intermediate Example and Comparative Example core polymer dispersions were used. For each example, the shell was prepared using BA (6 wt %), styrene (91.8 wt %), acrylic acid (2.0 wt %), and ALMA (0.8 wt %). The concentration of structural units of ammonium methacrylate was held constant at 39.2 weight percent, based on the weight of the core. Void Fraction (V.F. %), optical Rating (O.R.), and optical density at 0.25 mJ/dot (O.D.), were measured for each example by the following procedures.

### Measurement of Particle Size and Determination of Collapse Rating

The size of the HSPs was measured based on scanning electron micrographs (SEM). Two drops of the emulsions were drop-casted on a conductive carbon tape on an aluminum SEM tab. After drying for 2 h at ambient temperature, the samples were coated with a thin layer of chromium in an EMS 150T ES metal coater using 100 mA sputter current for 100 s. The SEMs were acquired at 5 kV acceleration voltage from a Schottky Field Emission electron source using an Everhart-Thornley secondary electron detector in a Thermo Fisher Nova NanoSEM 630 scanning electron microscope. All images were acquired at 20,000× magnification with an image size of 1024×884 pixels and a bit depth of 8 (grayscale ranges from 0 to 255, with 0 being the darkest and 255 being the brightest). All images had a horizontal field of view of 7.46 μm and a pixel size of 7.28 nm. Each image contained 40 to 60 HSPs. Two images were analyzed for each sample using the ImageJ software (version 1.53c). The diameter was measured manually for all particles in the image except for those at the edges of the images. The number-weighted average particle size was reported. The number of collapsed particles is counted and compared to the total number of particles, based on the fraction of collapsed particles a collapse rating is assigned as follows:
Rating 1: <10% collapsed particles
Rating 2: 10%-50% collapsed particles
Rating 3: >50% collapsed particles

### Measurement of Void Fraction

The particle void fraction was determined as follows. An aqueous dispersion of porous water-occluded core-shell polymer particles (40 g) was added a 50-mL polypropylene centrifuge. The tube was placed in a centrifuge and spun at 18,500 rpm for 120 min. The clear supernatant was decanted from the hard pack and weighed. From the latex mass, percent solids and supernatant mass, the percent void fraction (% VF) is determined using the following equations:

$${W}_{{S}_{0}} = {W}_{T} - \frac{{W}_{T} * ( \% Solids )}{k}$$

$$\% VF = \frac{{W}_{{S}_{0}} - {W}_{S}}{{W}_{T} - {W}_{S}} * 100 \%$$

W_{T}=Total weight of sample in the tube. The polymer densities were ~1 g/cm³ so weights are used in place of volumes.
% Solids=Solids content of the latex
k=Packing factor, 0.675, for random packing of unswollen monodisperse spheres. The packing factor accounts for the fact that some water will be trapped between the spheres in the hard pack.

### Preparation of Basecoat and Thermosensitive Recording Formulations

A basecoat formulation was made by mixing a portion of Example 2 (154.4 g), RHOPLEX™ P-308 Styrene-Acrylic Binder (7.5 g, 50 wt. % solids, A Trademark of The Dow Chemical Company or its Affiliates), and Polyvinyl Alcohol (8.3 g, 15 wt. % in demineralized water, cat. #67710 Kremer Pigmente), in a vessel with an overhead blade mixer, then diluted with DI water (22.0 g) to adjust to 13 wt. % solids. Basecoats of other examples and Comparative Example 1 were made using an equal dry weight for all components.

A thermosensitive recording layer was made from materials and formulations obtained from Nissho Kogyo Co, Ltd. DI water (51.6 g) was placed into an 8 oz. container, followed in order by the addition of Tunex-E precipitated calcium carbonate (4.4 g), P-603 Mizucasil silica dioxide (3.7 g), PVA-203 buffer (1.0 g, Kuraray 15% wt), D-8 4-hydroxy-4′-isopropoxydiphenylsulfone Developer (8.8 g, Mitsubishi, 50% wt %), 2-benzyl-oxy-napthalene Sensitizer (4.0 g, 40% wt), PVA-117 Binder (15.8 g, Kuraray, 10% wt.), zinc stearate Lubricant (3.1 g, 36% wt), and PSD-290 2-anilino-6-(dibutylamino)-3-methylfluoran Dye (5.7 g, Mitsubishi, 35% wt.), and mixed with an overhead blade mixer.

### Preparation of Thermosensitive Recording Article

NewPage freesheet paper (basis weight: 58 g/m², roughness: 4.00 μm, Gurley porosity: 24.6 s) was cut to 37.9 cm×20.1 cm with the long side in the machine direction, then placed at a controlled temperature room (22° C. and 50% humidity) for at least 2 h. The paper was taped using masking tape to a piece of copy paper that was attached to a hand-drawdown plate with masking tape. Then, a bead of basecoat formulation was pipetted onto the masking tape above the freesheet. A wire wound rod was then manually moved down over the strip of basecoat formulation, and across the paper so that the paper would be coated evenly. The paper was then exposed to hot air for 45 s, after which time the paper was transferred to an oven and dried at 80° C. for an additional 45 s. After drying, the paper was conditioned in a controlled temperature room (22° C. and 50% humidity) for 2 h. This paper with basecoat was then coated with a thermosensitive layer with the same procedure used to apply the basecoat, and dried for 1 min at 80° C.

### Measurement of Optical Density

Fully coated paper was cut in the machine direction into two strips 2.5″ (1 cm) wide. The two strips were taped end to end and printed using an Atlantek Paper Tester Model 200, using the following conditions:
a) sequence dot pulse duration=0.8 ms
b) full cycle time (T_{cycle})=5.0 ms
c) printhead temperature=30° C.
d) print head resistance=583 ohms at an applied voltage of 20.6 V

A 50% 80×80 checkerboard pattern was printed with print energies of 0.05, 0.10, 0.15, 0.20, 0.25, 0.30, 0.35, 0.40, 0.45, and 0.50 mJ/dot. The optical densities of 3 boxes for each print energy were measured using a handheld X-rite 428 spectrodensitometer.

Table 2 illustrates void fraction (V.F.), collapse rating (C.R.), and particle sizes (PS) for the HSPs arising from the porous water-occluded dispersions of Examples 1-4 and Comparative Examples 1 and 2, and optical densities at 0.25 mJ/dot (O.D.) for the corresponding thermosensitive recording materials.

TABLE 2
Property Dependency on Acrylate and MMA Variations in Core

| | BA | MMA | Solids | V.F. | | P.S. | |
|---|---|---|---|---|---|---|---|
| Ex. No. | wt % | wt. % | % | % | C.R. | μm | O.D. |
| Comp. 1 | 0 | 60.8 | 13.1 | 70.7 | 3 | 1.35 | 0.72 |
| Ex. 1 | 9.4 | 51.4 | 13.0 | 70.3 | 2 | 1.35 | 0.83 |
| Ex. 2 | 18.7 | 42.1 | 13.1 | 70.6 | 1 | 1.39 | 0.90 |
| Ex. 3 | 28.1 | 32.7 | 12.9 | 70.5 | 1 | 1.35 | 0.94 |
| Ex. 4 | 37.4 | 23.4 | 12.8 | 67.8 | 1 | 1.30 | N.M. |
| Comp. 2* | 60.8 | 0 | 13.0 | 55.7 | N.M. | N.M. | N.M. |

*Spherical HSPs not produced in this experiment

In the next series of experiments, dispersions of water-occluded core-shell polymer particles (Examples 5-7 and Comparative Example 3) were prepared as in Example 2 with different weight percentages of STY and BA, or STY and EA used to prepare the shell. The w/w ratio of the shell:core was 4:1 for each example. Table 3 show the relevant properties for HSPs arising from these dispersions.

TABLE 3
Property Dependency on Acrylate and STY Variations in Shell

| | BA | EA | STY | Solids | V.F. | | P.S. | |
|---|---|---|---|---|---|---|---|---|
| Ex. No. | wt % | wt % | wt % | % | % | C.R. | μm | O.D. |
| Comp. 3* | 0 | 0 | 97.8 | 12.8 | 26.2 | N.M. | N.M. | N.M. |
| Ex. 5 | 4 | 0 | 93.8 | 12.9 | 68.1 | 2 | 1.32 | N.M. |
| Ex. 2 | 6 | 0 | 91.8 | 13.1 | 70.6 | 1 | 1.39 | 0.90 |
| Ex. 6 | 12 | 0 | 85.8 | 12.9 | 71.1 | 1 | 1.35 | 0.88 |
| Ex. 7 | 0 | 9 | 88.8 | 12.5 | 64.7 | 1 | 1.25 | 0.72 |

*Incomplete swelling of water-occluded polymer particles

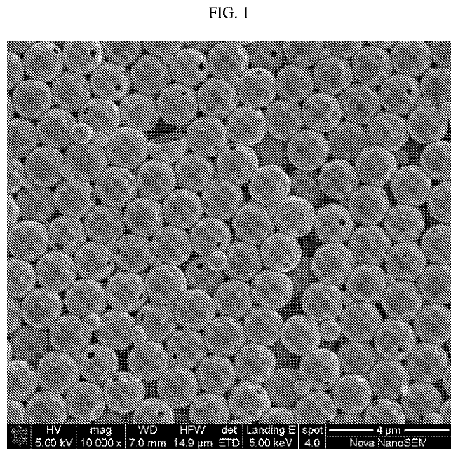

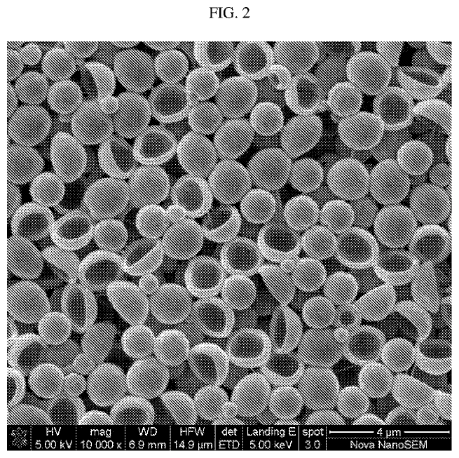

The data show that the properties of interest are improved by the presence of structural units of an acrylate monomer in the shell and the core. FIGS. 1 and 2 illustrate the dramatic differences in HSP integrity of HSPs prepared the dispersions of Example 6 and Comparative Example 1. More than 90% of HSPs arising from water-occluded core-shell particles made with BA in the core and shell stages are porous and retain spherical integrity. In contrast, a substantial portion of the HSPs arising from water-occluded core-shell particles prepared without BA in the core stage are non-porous and collapse into cup-shaped hemispheres.

### Example 8—Alternative Preparation of 18.7 BA Core/6 BA Shell Polymer Particles

The dispersion of water-occluded porous polymer particles with the composition of Example 2 was prepared by the following alternative process. Deionized water (2600.00 g), and glacial acetic acid (0.20 g) were charged to a 5-L, 4-necked round bottom flask and heated to 96° C. under N₂. ME1 containing DI water (134.00 g), NaDDBS (1.54 g, 22.5% in water), STY (330.48 g), BA (21.60 g), ALMA (0.72 g), and MAA (7.20 g) was prepared in a separate first vessel, and ME2 containing DI water (15.77 g), NaDDBS (0.18 g, 22.5% in water), and STY (40.00 g) was prepared in a second vessel. An initiator solution of sodium persulfate (1.51 g) in DI water (76.80 g) was also prepared. A solution of sodium persulfate (0.76 g) in DI water (10.40 g) was charged to the reactor and rinsed with DI water (4 g). A portion of the core polymer dispersion of Intermediate Example 2 (273.45 g) was charged to the reactor and rinsed with DI water (32 g). ME1 and initiator solution were then fed to the reactor over 120 min at 90° C., after which time, the vessels were rinsed with DI water (28 g total). A solution of iron sulfate heptahydrate (0.15% solution, 5.33 g) and VERSENE™ Chelating Agent (1.0% solution, 0.80 g) was added to the reactor and the reaction temperature maintained at 90° C. for 15 min. After the hold, a solution of 4-hydroxy-TEMPO (2.40 g, 5% active) was added to the reactor. ME2 was then charged to the reactor and rinsed with DI water (24 g). A neutralizer solution was prepared from DI water (120 g), NaDDBS (10.68 g, 22.5% in water), and ammonium hydroxide (30%, 33.42 g). The neutralizer solution was added to the reactor over 15 min and the vessel containing the solution was rinsed with DI water (16 g) and added to the reactor. The contents of the reactor were held at 90° C. for 15 min, after which time a solution of t-BHP (70% solution, 2.40 g in 12 g DI water) was added to the reactor, followed by the addition of IAA (1.33 g in 76.80 g DI water) over 15 min and a rinse with DI water rinse (4 g). The contents of the reactor were then cooled to room temperature and filtered to remove any coagulum. The dispersion had a solids content of 13.1% and a pH of 9.1. The HSP had a void fraction of 74.1%, a collapse rating of 2, and a particle of 1.42 μm. The resulting thermosensitive recording material demonstrated an optical density at 0.25 mJ/dot of 0.97.

### Example 9—Alternative Preparation of 18.7 BA Core/12 BA Shell Polymer Particles

The dispersion of water-occluded porous polymer particles was prepared by the process described in Example 8, except that the amounts of STY (308.88 g) and BA (43.2 g) in ME1 were changed. The dispersion had a solids content of 13.3% and a pH of 9.2. The HSP had a void fraction of 71.4%, a collapse rating of 1, and a particle size of 1.38 μm. The resulting thermosensitive recording material demonstrated an optical density at 0.25 mJ/dot of 0.99.

1. A composition comprising an aqueous dispersion of porous core-shell polymer particles having:
a) a water-occluded core containing a core polymer phase comprising 1) from 30 to 55 weight percent structural units of a salt of a carboxylic acid monomer; 2) from 4.5 to 55 weight percent structural units of n-butyl acrylate or 2-ethyhexyl acrylate, or a combination thereof; and 3) from 4.5 to 55 weight percent structural units of methyl methacrylate; and
b) a shell comprising 1) from 3.4 to 16 weight percent structural units of one or more acrylate monomers selected from the group consisting of ethyl acrylate, n-butyl acrylate, and 2-ethylhexyl acrylate; and 2) from 80 to 96.4 weight percent structural units of styrene;
wherein the porous core-shell polymer particles having a number average particle size in the range of from 750 nm to 2 μm.

2. The composition of claim 1 wherein the core polymer phase comprises from 35 to 45 weight percent structural units of a salt of a carboxylic acid monomer; from 9 to 50 weight percent structural units of n-butyl acrylate or 2-ethyhexyl acrylate, or a combination thereof; and from 9 to 50 weight percent structural units of methyl methacrylate;
wherein the shell comprises from 4 to 15 weight percent structural units of the one or more acrylate monomers; and from 84 to 94 weight percent structural units of styrene;
wherein the porous core-shell polymer particles having a number average particle size in the range of from 900 nm to 2 μm; and
wherein the weight-to-weight ratio of the shell to the core polymer phase is in the range of from 2.5:1 to 7:1.

3. The composition of claim 2 wherein the core polymer phase comprises from 38 to 42 weight percent structural units of a salt of a carboxylic acid monomer, wherein the salt of the carboxylic acid monomer is ammonium methacrylate or sodium methacrylate; from 12 to 50 weight percent structural units of n-butyl acrylate or 2-ethyhexyl acrylate, or a combination thereof; and from 13 to 50 weight percent structural units of methyl methacrylate; and
wherein the shell comprises from 4 to 13 weight percent structural units of the one or more acrylate monomers; and from 85 to 94 weight percent structural units of styrene.

4. The composition of claim 3 wherein the shell further comprises from 0.1 to 5 weight percent structural units of an acid monomer salt and from 0.05 to 1 weight percent structural units of a multiethylenically unsaturated monomer; wherein the porous core-shell polymer particles have a number average particle size in the range of from 1.1 μm to 1.5 μm; and
wherein the weight-to-weight ratio of the shell to core polymer phase is in the range of from 3.0:1 to 6.0:1.

5. The composition of claim 4 wherein the shell comprises from 5 to 13 weight percent structural units of n-butyl acrylate; from 85 to 93 weight percent structural units of styrene; from 1 to 3.5 weight percent structural units of the salt of the acid monomer, wherein the salt of the acid monomer is ammonium methacrylate or sodium methacrylate; and from 0.1 to 0.5 weight percent of the multiethylenically unsaturated monomer, which is allyl methacrylate; and
wherein the weight-to-weight ratio of the shell to core polymer phase is in the range of from 3:5:1 to 4.5:1.

6. A composition comprising an aqueous dispersion of porous core-shell polymer particles having:
a) a water-occluded core containing a core polymer phase comprising, based on the weight of the core polymer phase, 1) from 35 to 45 weight percent structural units of ammonium methacrylate or sodium methacrylate; 2) from 12 to 45 weight percent structural units of n-butyl acrylate; and 3) from 18 to 45 weight percent structural units of methyl methacrylate; wherein at least 95 weight percent of the core polymer phase comprises structural units of ammonium methacrylate or sodium methacrylate, n-butyl acrylate, and methyl methacrylate; and
b) a shell comprising, based on the weight of the shell, 1) from 5 to 15 weight percent structural units of n-butyl acrylate; 2) from 85 to 93 weight percent structural units of styrene; and
wherein the porous core-shell polymer particles having a number average particle size in the range of from 1 μm to 2 μm; and wherein the weight-to-weight ratio of the core polymer phase to the shell is in the range of from 3.0:1 to 5.0:1.

7. The composition of claim 6 wherein at least 99 weight percent of the core polymer phase comprises structural units of a) ammonium methacrylate or sodium methacrylate; b) n-butyl acrylate; and c) methyl methacrylate; wherein the shell further comprises, based on the weight of the shell, from 0.1 to 0.5 weight percent structural units of allyl methacrylate and from 0.5 to 3.5 weight percent structural units of a sodium or ammonium salt of acrylic acid or methacrylic acid; wherein the weight-to-weight ratio of the shell to the core polymer phase is in the range of from 3.5:1 to 4.5:1; and wherein the porous core-shell polymer particles have a number average particle size in the range of from 1.0 μm to 1.8 μm.

8. The composition of claim 7 wherein the sodium or ammonium salt of acrylic acid or methacrylic acid is sodium methacrylate or ammonium methacrylate and wherein the porous core-shell polymer particles have a number average particle size in the range of from 1.1 μm to 1.5 μm.
